(19) United States
(12) Patent Application Publication
(10) Pub. No.: US 2002/0078052 A1
(43) Pub. Date: Jun. 20, 2002

(54) Automatic distribution list management

(76) Inventor: Heung-For Cheng, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/741,200

(22) Filed: Dec. 19, 2000

(51) Int. Cl. G06F 7/00

(52) U.S. Cl. 707/10

(57) ABSTRACT

Automatic distribution list management to reduce network bandwidth wastage incident to sending an electronic document to a nonexistent member of a distribution list. For a document by a document distribution server, an identifier of the document and distribution list is recorded in a database. The document is distributed to members of the distribution list. If an error including the identifier is received in response to distributing to a member of the distribution list, the identifier is looked up in the database so as to identify the distribution list. The member is deleted from the distribution list so that subsequent sending to the distribution list avoids subsequent error messages and network bandwidth wastage incident thereto.

### Field of the Invention

The invention generally relates to distribution list management, and more particularly to reducing network bandwidth wastage due bandwidth consumption in sending a message to an invalid list member, receiving responsive error messages, and receiving replies to the list causing duplicative bandwidth wastage.

### Background

With the advent of easy networking connections, Microsoft Windows and other operating systems have begun to provide powerful messaging systems to allow easy electronic distribution of a variety of documents. (Please note that all registered marks references herein belong to their respective owners.) These systems facilitate transfer of arbitrary data, such as text documents, word processing documents, binary data files, graphics, charts, web pages (e.g., documents formatted with the HyperText Markup Language (HTML), Java, JavaScript), application programs, and the like.

In Microsoft Windows, e.g., Windows 3.x, Windows 95, Windows NT, Windows 2000, Windows ME, Windows CE, etc. (hereafter Windows), for example, Windows provides for sending an receiving E-mail as part of the Windows operating system through use of the Windows Messaging Application Programming Interface (MAPI), and Active Messaging, which is a programming environment using the functions and structures of the MAPI. Active Messaging is a Component Object Model (COM) wrapper around MAPI which encapsulates MAPI functions and provides an object model for messaging development.

The Microsoft Outlook application program is a well known application program used for sending E-mail. Working in conjunction with a mail server (which may simply be Outlook or another E-mail application program), users of Outlook may elect to send electronic documents to single users, or entire groups of persons. To facilitate distribution to groups, Outlook and other mailing systems support distribution lists, where a message can be addressed to a distribution list, and be distributed to all member addresses of the list. Each recipient receives a message showing the list as the addressee, so that it will be appreciated that the received message was addressed to the distribution list.

Unfortunately, in a fast paced environment, distribution lists can become unwieldy to manage. In particular, as distribution lists obtain and lose many members, it can become extremely difficult to ensure all distribution list members have valid addresses. For example, if a distribution list member address becomes invalid, such as due to an employee leaving employment, switching work groups, etc., mailings to the distribution list will unnecessarily consume network bandwidth incident to the mailings and error messages responsive thereto.

### BRIEF DESCRIPTION OF THE DRAWINGS

The features and advantages of the present invention will become apparent from the following detailed description of the present invention in which:

FIG. 1 illustrates manual management of a distribution list.

FIG. 2 illustrates an exemplary E-mail message addressed to a distribution list.

FIG. 3 illustrates an exemplary environment providing a for automated distribution list management.

FIG. 4 is a flowchart illustrating automated distribution list management.

FIG. 5 illustrates a suitable computing environment in which certain aspects of the invention may be implemented.

### DETAILED DESCRIPTION

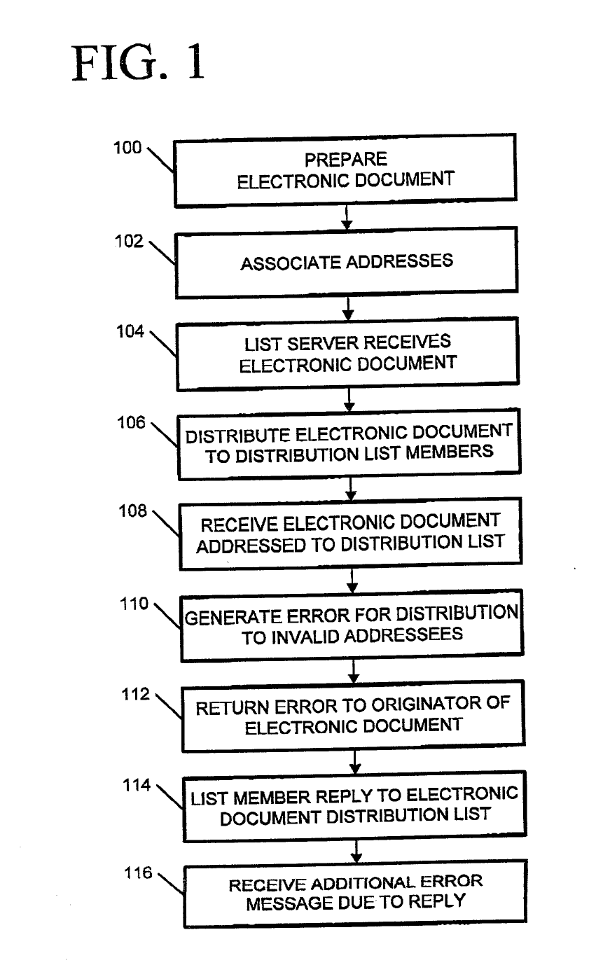

FIG. 1 illustrates manual management of a distribution list. A user prepares 100 an electronic document. For the purposes of this description and claims that follow, it is assumed that the electronic document is prepared with an E-mail application program with a mail user agent (MUA) such as Windows' Outlook, Qualcomm's Eudora, Unix/Linux's (or equivalent) Pine, Elm, Emacs, Mail/sendmail, or other application program for preparing E-mail or other arbitrary data for transmission to recipients.

After preparing 100 the electronic document, addresses are associated 102 with the electronic document, e.g., in an E-mail application program, the electronic document is assigned destination E-mail addresses. Assuming a distribution list addressee, the electronic document is then sent to each member of the distribution list. To do so, a list server or equivalent, containing a correspondence between the distribution list and each individual list member, receives 104 the electronic document and distributes 106 the electronic document to each distribution list member.

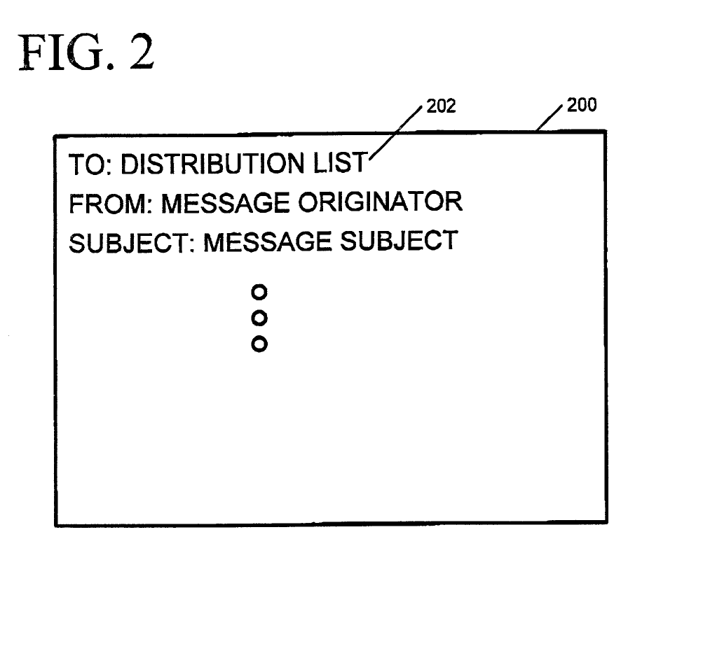

Each valid distribution list member receives 108 a copy of the electronic document indicating an address of the distribution list. FIG. 2 illustrates an exemplary E-mail message 200 addressed 202 to a distribution list. It is assumed the address 202 is received and displayed by each distribution list member.

When members of the distribution list have invalid addresses, distributing 106 the electronic document to a nonexistent list member causes an error to be generated 110. This error is returned 112 to the originator of the electronic document. Thus, network wastage occurs since bandwidth was unnecessarily consumed in distributing 106 the electronic document to the nonexistent list member, and in sending 112 a responsive error message. Additional network wastage occurs when other list members reply 114 to the distributed 106 message, since the reply is directed to the distribution list, and thus further requires bandwidth to transmit that reply to the invalid addressee. Still further wastage occurs in error messages received 116 in response to the reply 114.

To correct this, in Microsoft Outlook and similar environments, the originator of the message must manually revise 118 the distribution list to exclude the nonexistent list member, or notify a list manager who then edits the distribution list.

This is inefficient.

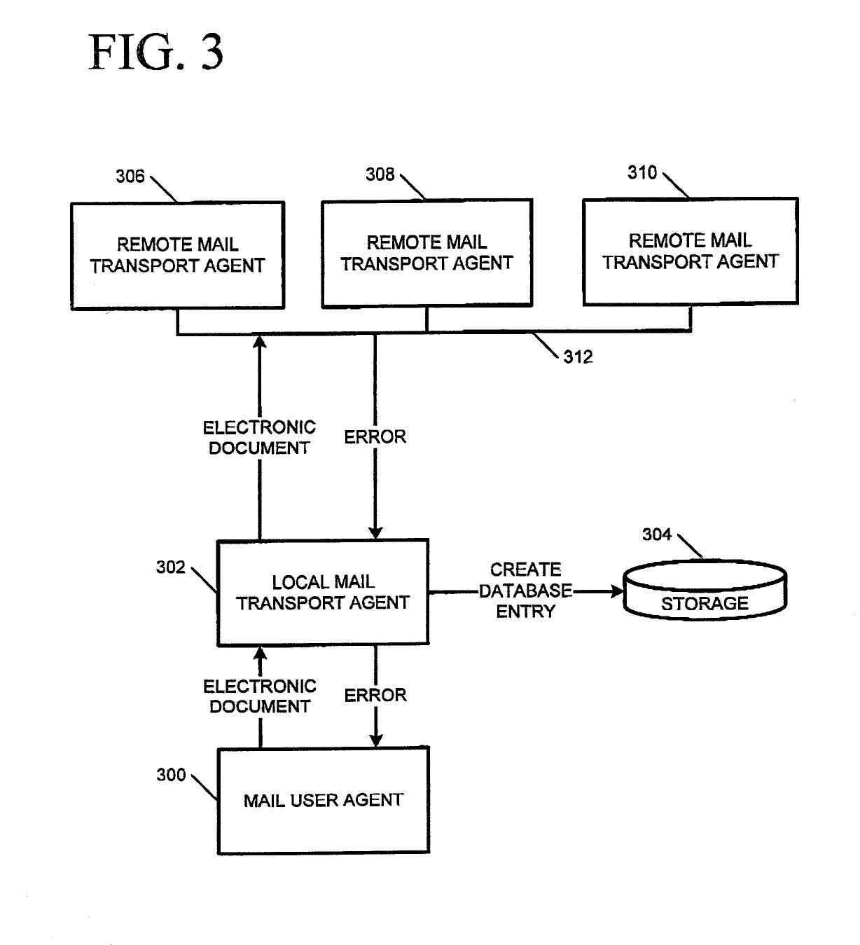

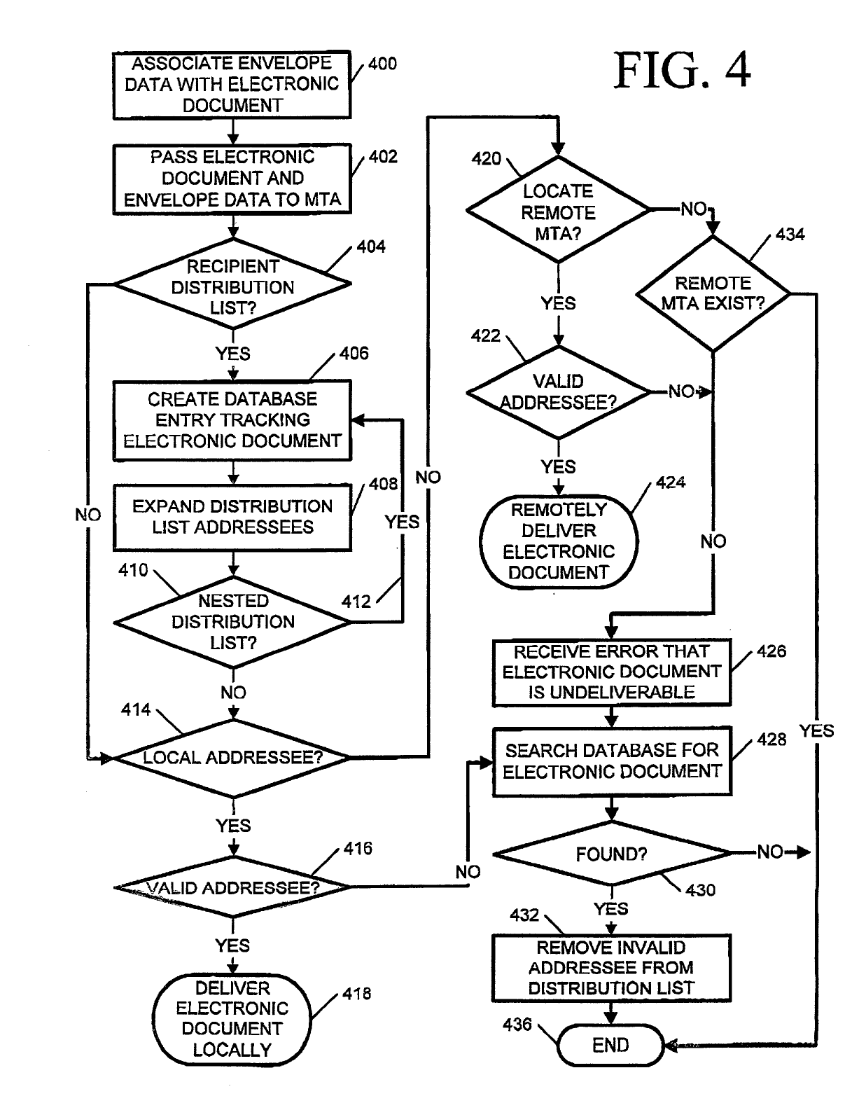

FIG. 3 illustrates an exemplary environment providing automated distribution list management. In particular, as will be discussed in FIG. 4, this overcomes deficiencies in the Microsoft Outlook and similar contexts where one must manually remove nonexistent distribution list members. As illustrated, there is a mail user agent (MUA) 300, a mail transport agent (MTA) 302, a database 304, and remote MTAs 306-310 shown in communication with MTA 302 over a communication pathway 312.

As discussed above, the MUA may be a client E-mail application program such as Microsoft Outlook, Qualcomm's Eudora, etc. The MUA can be used to associate addresses with an electronic document, e.g., a distribution list, and a subject reference, and provide this electronic document to the MTA 302. A well-known MTA in Unix-based operating systems is the “sendmail” program.

The MTA 302 acts as a data conduit for the electronic document received from the MUA 300, and transfers the electronic document to remote MTA's 306-310 according to associated addresses for the electronic document. Addresses are assumed to have both an addressee name (which may in turn be another distribution list), and a domain name or other destination identifier for a computing device cable of receiving documents for addressees. A network address is determined for a remote MTA 306-310 configured to handle receiving documents for the domain name and deliver them to the addressee name. In one embodiment, such determination is by a Domain Name Server (DNS) lookup identifying a mail server handling delivery for the addressee domain name.

In the illustrated embodiment, the database 304 tracks electronic documents sent by the MUA 300 to distribution lists. In one embodiment, each database entry includes the distribution list identifier, electronic document subject reference, and a sending time and/or date at which the MUA sent (or MTA received) a electronic document.

FIG. 4 is a flowchart according to FIG. 3 illustrating automated distribution list management. In this illustrated embodiment, a MUA 300 (which may be operated by a person or other computing device) associates 400 envelope data, e.g., addressees, subject reference, etc., with an electronic document. In one embodiment, the electronic document is an electronic mail (E-mail) message that has been composed with a user interface to a MUA, e.g., Microsoft Outlook or other E-mail user interface.

When the MUA is ready to send the electronic document, it passes 402 the electronic document and envelope data to a local MTA 302. In one embodiment, the electronic envelope data comprises both the sender's electronic mail address, the recipient's electronic mail address, a subject reference, and a payload, e.g., the electronic document. Note that a mail list server receiving an electronic mail and processing distribution lists may be considered an MUA with respect to its sending an electronic document to distribution list members.

The local MTA 302 maintains a database 304 tracking E-mail messages or other electronic documents addressing distribution addressees. Each database entry includes a distribution list identifier, E-mail subject reference, and sending time and/or date. When the passed electronic document is received by the local MTA, the electronic document's addressees are inspected to determine if 404 a recipient is a distribution list. If so, the local MTA creates 406 an entry in the database for the electronic document. Then, for each addressee, the MTA expands 408 the distribution list into its constituent recipients. If 410 an expanded addressee is a nested distribution list, processing recurses 412.

After entering distribution lists in the database 304, for each constituent recipient, the local MTA 302 determines if 414 a recipient is a local addressee. If local, then the MTA determines if 416 that the local addressee is valid. If so, the electronic document is delivered 418 locally, e.g., for an E-mail, it is delivered to a local mailbox, spool file, memory location, or other storage configured to receive mailings.

If 414 not a local addressee, the local MTA 302 attempts to locate, such as through a DNS lookup as discussed above, or other location method, a remote MTA 306-310 that can handle distribution of the electronic document. If 420 the local MTA contacts a remote MTA, the electronic document is given to the remote MTA for handling. In one embodiment, the remote MTA determines if 422 the remote addressee is a valid address. If so, the remote MTA delivers 424 the electronic document to the addressee for the local MTA. It will be appreciated an addressee may be a distribution list known to a remote MTA, in which case, the illustrated embodiment may be practiced by the remote MTA.

However, if 420 the attempt to contact the remote MTA fails, in one embodiment, a check is made to determine if 434 the remote MTA exists. If 434 the remote MTA exists, then processing ends 436 since no address validity determination can be made when the remote MTA exists, but cannot be contacted. In one embodiment, if 420 contact fails, verification of the remote address is queued for later verification (not illustrated).

If 434 the remote MTA does not exist, or if 416, 422 the addressee is not valid, then the local MTA receives 426 an error indicating the electronic document is undeliverable. In one embodiment, the error specifies the nature of the error, e.g., the remote MTA can not be located, the remote addressee is invalid. In an E-mail context, the received error is a “bounced” E-mail error indicating that the electronic document could not be delivered to a specific addressee.

When the local MTA 302 receives 426 the error, the database 304 is searched 428 to locate the database entry corresponding to the received error. In one embodiment, the received error includes the electronic document subject reference, sending time and/or date, and addressee giving rise to the error, but does not indicate the distribution list associated with the error. The subject and sending time and/or date is used to search 428 the database to locate a corresponding database entry indicating the distribution list including the invalid addressee.

If 430 an appropriate distribution list is located by searching 428 the database, the invalid addressee is removed 432. If an appropriate distribution list is not located, then processing ends 436.

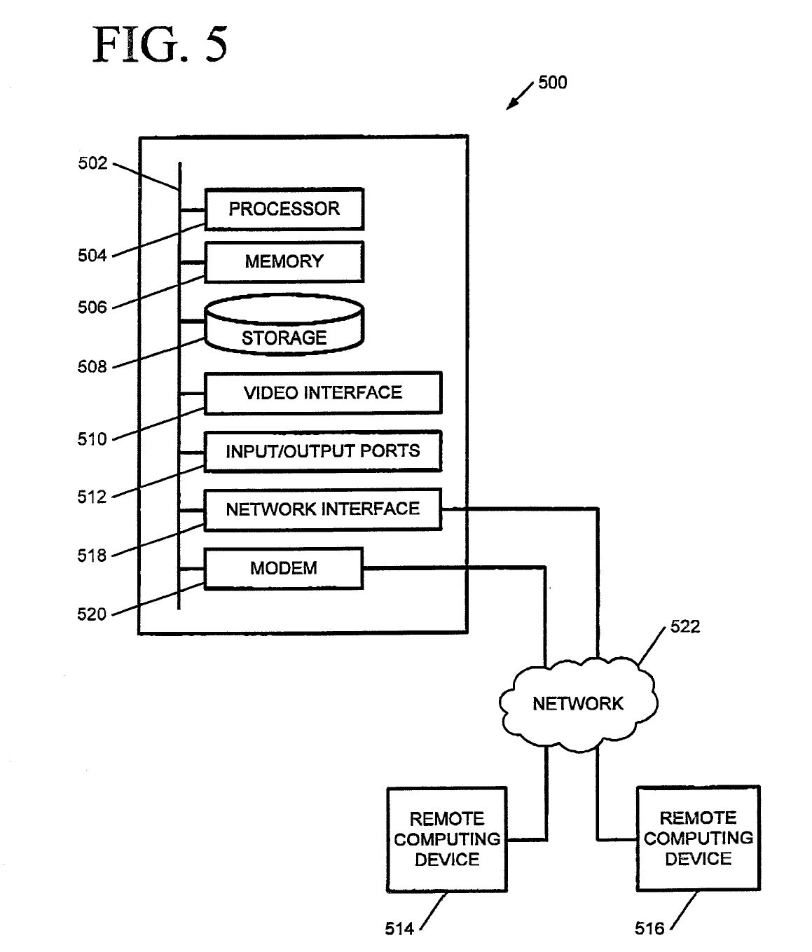

FIG. 5 and the following discussion are intended to provide a brief, general description of a suitable computing environment in which certain aspects of the illustrated invention may be implemented.

An exemplary system for implementing the invention includes a computing device 500 having system bus 502 for coupling various computing device components. Typically, attached to the bus are non-programmable and programmable processors 504, a memory 506 (e.g., RAM, ROM), storage devices 508, a video interface 510, and input/output interface ports 512. Storage devices include hard-drives, floppy-disks, optical storage, magnetic cassettes, tapes, flash memory cards, memory sticks, digital video disks, and the like.

The invention may be described by reference to different high-level program modules and/or low-level hardware contexts. Those skilled in the art will realize that program modules can be interchanged with low-level hardware instructions. Program modules include procedures, functions, programs, components, data structures, and the like, for performing particular tasks or implementing particular abstract data types. Modules may be incorporated into single and multi-processor computing devices, Personal Digital Assistants (PDAs), cellular telephones, and the like. Thus, the storage systems and associated media can store data and executable instructions for the computing device.

The computing device is expected to operate in a networked environment using logical connections to one or more remote computing devices 514, 516 through a network interface 518, modem 520, or other communication pathway. Computing devices may be interconnected by way of a network 522 such as an intranet, the Internet, or other network. Modules may be implemented within a single computing device, or processed in a distributed network environment, and stored in both local and remote memory. Thus, for example, with respect to the illustrated embodiments, assuming computing device 500 is Mail User Agent (MUA) 300, then remote devices 514, 516 may respectively be local and remote Mail Transfer Agents (MTA) 302, 306.

It will be appreciated that remote computing devices 514, 516 may be configured like computing device 500, and therefore include many or all of the elements discussed for computing device. It should also be appreciated that computing devices 500, 514, 516 may be embodied within a single device, or separate communicatively-coupled components, and may include or be embodied within routers, bridges, peer devices, web servers, and application programs utilizing network application protocols such as the HyperText Transfer Protocol (HTTP), File Transfer Protocol (FTP), and the like.

Having described and illustrated the principles of the invention with reference to illustrated embodiments, it will be recognized that the illustrated embodiments can be modified in arrangement and detail without departing from such principles.

And, even though the foregoing discussion has focused on particular embodiments, it is understood that other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless implicitly or expressly indicated otherwise, embodiments are combinable into other embodiments. Consequently, in view of the wide variety of permutations to the above-described embodiments, the detailed description is intended to be illustrative only, and should not be taken as limiting the scope of the invention.

What is claimed as the invention, therefore, is all such modifications as may come within the scope and spirit of the following claims and equivalents thereto.

What is claimed is:

1. A method for reducing network bandwidth wastage incident to sending an electronic document to a nonexistent member of a distribution list, comprising:
receiving a document by a document distribution server;
recording in a database an identifier for the document and the distribution list;
distributing the document to said members of the distribution list;
receiving, in response to distributing to a first member of the distribution list, an error message comprising the identifier;
looking up the identifier in the database so as to identify the distribution list; and
deleting the first member from the distribution list so that a subsequent sending to the distribution list avoids corresponding subsequent error messages.

2. The method of claim 1, wherein said wastage comprises bandwidth required for:
said distributing the document to the nonexistent member;
said error message received in response to said distributing;
a reply by a second member of the distribution list, in response to said distributing, which is distributed to the nonexistent member; and
an error message responsive to said reply.

3. The method of claim 1, wherein members of the distribution list receive distributions addressed such that replies to said distributions are directed to said members of the distribution list.

4. The method of claim 3, further comprising:
disposing a Messaging Application Programming Interface (MAPI) application program within a first computing device;
composing by the user of the document with said application program; and
disposing the document distribution server in a second computing device.

5. The method of claim 4, wherein said application program includes an object-oriented programming language

6. The method of claim 4, wherein said application program comprises a Microsoft Outlook e-mail functionality.

7. The method of claim 1, further comprising:
providing a Microsoft Windows operating system environment having a Messaging Application Programming Interface (MAPI);
disposing a MAPI application program within a first computing device;
composing by the user of the document with said application program; and
disposing the document distribution server in a second computing device.

8. A method for reducing network bandwidth wastage incident to sending an electronic document to a nonexistent member of a distribution list, comprising:
executing an e-mail application program utilizing a selected one of: Microsoft Messaging Application Programming Interface (MAPI)-based, and Microsoft Active Messaging;
addressing the electronic document to the distribution list;
recording in a database an identifier cross-referencing the electronic document with the distribution list;
sending the electronic document with said MAPI application program;
distributing the electronic document to members of the distribution list;
receiving an error message for said distributing to the nonexistent member, said error message comprising the identifier;
looking up the identifier of said error message in the database so as to identify the distribution list; and
deleting the nonexistent member from the distribution list.

9. The method of claim 8, further comprising:
receiving the electronic document by a distribution server which performs said distributing the electronic document, receiving the error message, and looking up the identifier.

10. The method of claim 8, further comprising:
determining the identifier based on attributes of the electronic document, said attributes comprising a subject identifier, a sending time, and a distribution list identifier.

11. An apparatus for reducing network bandwidth wastage incident to sending an electronic document to a nonexistent member of a distribution list, comprising:
a machine accessible medium having instructions encoded thereon, which when executed by the machine, are capable of directing the machine to perform:
receiving a document by a document distribution server;
recording in a database an identifier for the document and the distribution list;
distributing the document to said members of the distribution list;
receiving, in response to distributing to a first member of the distribution list, an error message comprising the identifier;
looking up the identifier in the database so as to identify the distribution list; and
deleting the first member from the distribution list so that a subsequent sending to the distribution list avoids corresponding subsequent error messages.

12. The apparatus of claim 11 said instructions including further instructions capable of directing the machine to perform:
receiving distributions addressed to the distribution list so that replies to said distributions are directed to said members of the distribution list.

13. The apparatus of claim 12, said instructions including further instructions capable of directing the machine to perform:
disposing a Messaging Application Programming Interface (MAPI) application program within a first computing device;
composing by the user of the document with said application program; and
disposing the document distribution server in a second computing device.

14. The apparatus of claim 11, wherein said application program includes an object-oriented programming language.

15. The apparatus of claim 11, wherein said application program comprises a Microsoft Outlook e-mail functionality.

16. The apparatus of claim 11, further comprising:
a second computing device, communicatively coupled to the system, in which the document distribution server is disposed; and
wherein said instructions include further instructions capable of directing the machine to perform: executing a Microsoft Windows operating system environment providing a Messaging Application Programming Interface.

17. An apparatus for reducing network bandwidth wastage incident to sending an electronic document to a nonexistent member of a distribution list, comprising:
a machine accessible medium having instructions encoded thereon capable of directing the machine to perform:
executing a Messaging Application Programming Interface (MAPI)-based e-mail application program;
addressing the electronic document to the distribution list;
recording in a database an identifier cross-referencing the electronic document with the distribution list;
sending the electronic document with said MAPI application program;
distributing the electronic document to members of the distribution list;
receiving an error message for said distributing to the nonexistent member, said error message comprising the identifier;
looking up the identifier of said error message in the database so as to identify the distribution list; and
deleting the nonexistent member from the distribution list.

18. The apparatus of claim 17, said instructions including further instructions capable of directing the machine to perform:
receiving the electronic document by a distribution server which performs said distributing the electronic document, said receiving the error message, and said looking up the identifier.

19. The apparatus of claim 17, said instructions including further instructions capable of directing the machines to perform:
determining the identifier based on attributes of the electronic document, said attributes comprising a subject identifier, a sending time, and a distribution list identifier.
